(19) United States
(12) Patent Application Publication
(10) Pub. No.: US 2010/0049548 A1
(43) Pub. Date: Feb. 25, 2010

(54) MEDICAL IMAGE SYSTEM, ELECTRONIC MEDICAL RECORD TERMINAL, AND COMPUTER-READABLE MEDIUM

(75) Inventor: Hiroyuki Kubota, Tokyo (JP)

Correspondence Address: CANTOR COLBURN, LLP, 20 Church Street, 22nd Floor, Hartford, CT, 06103, US

(73) Assignee: KONICA MINOLTA MEDICAL & GRAPHIC, INC., Tokyo (JP)

(21) Appl. No.: 12/524,468

(22) PCT Filed: Nov. 22, 2007
(86) PCT No.: PCT/JP2007/072631

§ 371 Date: Jul. 24, 2009

(30) Foreign Application Priority Data
Jan. 25, 2007 (JP) 2007-014893

(51) Int. Cl. G06Q 50/00

(52) U.S. Cl. 705/3

(57) ABSTRACT

Conformation of a medical image is facilitated. A medical image system includes an electronic medical record terminal and an image server. The electronic medical record terminal creates order information on medical images stored in the image server and stores it. Medical images created according to the order information are stored in the image server. The image server manages medical images together with information on the medical images based on the order information as additional information. The electronic medical record terminal acquires a medical image and the additional information from the image server, judges on the basis of the acquired additional information on the medical image and instruction information on the stored medical image whether or not the acquired medical image is the one complying with the instruction information, and outputs the judgment result.

### TECHNICAL FIELD

The present invention relates to a medical image system which provides a medical image, an electronic medical record terminal which receives a medical image, and a computer-readable medium.

### BACKGROUND ART

In medical institutions, an image server, which manages and stores electronic data of medical images or interpretation reports which have been acquired from a radiological department, cooperates with a terminal having a function of an electronic medical record for generating an electronic medical record (hereinafter “electronic medical record terminal”) so that a physician in a diagnosis and treatment department can directly see the medical images or the interpretation reports which have been held in the radiological department (For example, see Patent Literature 1).

In the image server, medical images are stored and managed to meet DICOM (Digital Imaging and Communications in Medicine) standards. The medical images are converted to JPEG or PDF to provide to the electronic medical record terminal via Web communication so that the electronic medical record function of the electronic medical record terminal allows the images to be seen easily. Because data in PDF format or JPEG format is small in data size and is used widely, the electronic medical record terminal can display the medical images on a commonly-used browser such as Web browser.

### Patent Literature 1: JP-A-10-79770

### DISCLOSURE OF INVENTION

### Problem to be Solved by the Invention

The electronic medical record function mainly handles text information indicating findings or medical examination results, and secondly manages medical images and interpretation reports by attaching JPEG compressed images or print images of the interpretation reports in PDF format to electronic medical records. In recent years, physicians wish to not only simply see a medical image on the electronic medical record but also see the medical image in a suitable method for reference. Unfortunately, because the electronic medical record terminal receives data in JPEG format or PDF format, image processing cannot be carried out using this data.

Moreover, whereas a medical image in DICOM standard has additional various information for specifying the medical image individually (such as information on a patient to be photographed and information on photographing, examination and an image itself), the data in JPEG format or PDF format does not have such additional information. Therefore, the electronic medical record terminal does not have information on the medical image, and cannot acquire necessary information for medical examination, such as a photographing condition of the medical mage.

Furthermore, a physician who only receives and sees the medical image in a JPEG or PDF file cannot confirm identity of a desired patient by simply specifying the JPEG or PDF file for the desired patient by connecting to a URL via Web communication because the URL information may be incorrect or a JPEG file for another patient may be specified by mistake.

It is, therefore, an object of the present invention to facilitate confirmation of a medical image.

### Means for Solving the Problem

According to a first aspect of the present invention, there is provided a medical image system, including: an image server to store a medical image in a manner associated with additional information on the medical image; and an electronic medical record terminal to generate an electronic medical record, wherein the electronic medical record terminal includes: a storage section to store order information on the medical image stored in the image server; an acquiring section to acquire the medical image and the additional information from the image server; and a determination control section to determine whether the acquired medical image is based on the order information using the acquired additional information of the medical image and the stored order information of the medical image, and to output a determination result.

Preferably, the electronic medical record terminal further includes: a display section to display a medical image; and a display control section to cause the display section to display the acquired medical image if the determination control section determines that the acquired medical image is based on the order information.

Preferably, the display control section causes the acquired medical image and the additional information thereof to be displayed.

Preferably, the electronic medical record terminal further includes an image processing section to perform image processing on the acquired medical image; and the display control section causes the display section to display the medical image on which the image processing has been performed.

Preferably, the acquiring section acquires the medical image in accordance with a protocol for Web communication.

Preferably, the image server stores an interpretation report of the medical image in a manner associated with additional information of the medical image; the acquiring section of the electronic medical record terminal acquires the medical image and the interpretation report thereof from the image server; and the determination control section of the electronic medical record terminal determines whether the acquired interpretation report is based on the order information using the additional information of the acquired interpretation report and the order information, and to output a determination result.

Preferably, the electronic medical record terminal further includes: a display section to display an interpretation report; and a display control section to cause the display section to display the medical image if the determination control section determines that the acquired interpretation report is based on the order information.

According to a second aspect of the present invention, there is provided an electronic medical record terminal for generating an electronic medical record, including: a storage section to store order information on a medical image which is stored in an image server in a manner associated with additional information on the medical image; an acquiring section to acquire the medical image and the additional information from the image server; and a determination control section to determine whether the acquired medical image is based on the order information using the acquired additional information of the medical image and the stored order information of the medical image, and to output a determination result.

According to a third aspect of the present invention, there is provided a computer-readable medium embodying a program causing a computer to function as: a storage control section to cause a storage section to store order information on a medical image which is stored in an image server in a manner associated with additional information on the medical image; an acquiring section to acquire the medical image and the additional information from the image server; and a determination control section to determine whether the acquired medical image is based on the order information using the acquired additional information of the medical image and the order information of the medical image, which is stored in the storage section, and to output a determination result.

### EFFECT OF THE INVENTION

According to the invention, it is possible to confirm whether a medical image is for the patient concerned, i.e., to readily confirm authenticity of the medical image. It is also possible to easily confirm whether the medical image which is consistent with order information has been acquired.

Specifically, it is possible to provide a physician with a medical image which is determined to be correct, thereby avoiding misidentification of patients.

More specifically, it is also possible to provide the physician with additional information along with the medical image. This allows the physician to easily recognize the information on the displayed medical image and effectively use the information for medical examination.

More specifically, image processing can be carried out by an electronic medical record terminal to change the medical image into a desired image that a physician wants to view. This allows the physician to perform a physical examination efficiently using the desired image.

More specifically, the medical image can be acquired in accordance with a protocol for commonly-used Web communication. Therefore, it is possible to use an existing system configuration instead of establishing a DICOM-compliant system.

Specifically, the electronic medical record terminal allows a physician to easily see an interpretation report. It is also possible to readily confirm authenticity of the interpretation report and confirm whether the interpretation report has been generated as instructed.

More specifically, it is possible to provide a physician with an interpretation report which is determined to be correct, thereby avoiding misidentification of patients and medical images.

### BRIEF DESCRIPTION OF DRAWINGS

FIG. 1 shows a configuration of a medical image system according to embodiments of the present invention.

FIG. 2 shows a configuration of an image server shown in FIG. 1.

FIG. 3 shows a configuration of an electronic medical record terminal shown in FIG. 1.

FIG. 4 shows a flowchart for explaining a processing flow in the medical image system.

FIG. 5 shows an explanatory diagram for generation of a DICOM-compliant medical image.

FIG. 6A shows exemplary additional information of a medical image.

FIG. 6B shows exemplary additional information of a medical image.

FIG. 6C shows exemplary additional information of a medical image.

FIG. 6D shows exemplary additional information of a medical image.

FIG. 6E shows exemplary additional information of a medical image.

FIG. 7 shows an exemplary screen for generating an electronic medical record.

### BEST MODE FOR CARRYING OUT THE INVENTION

Reference will now be made to a configuration.

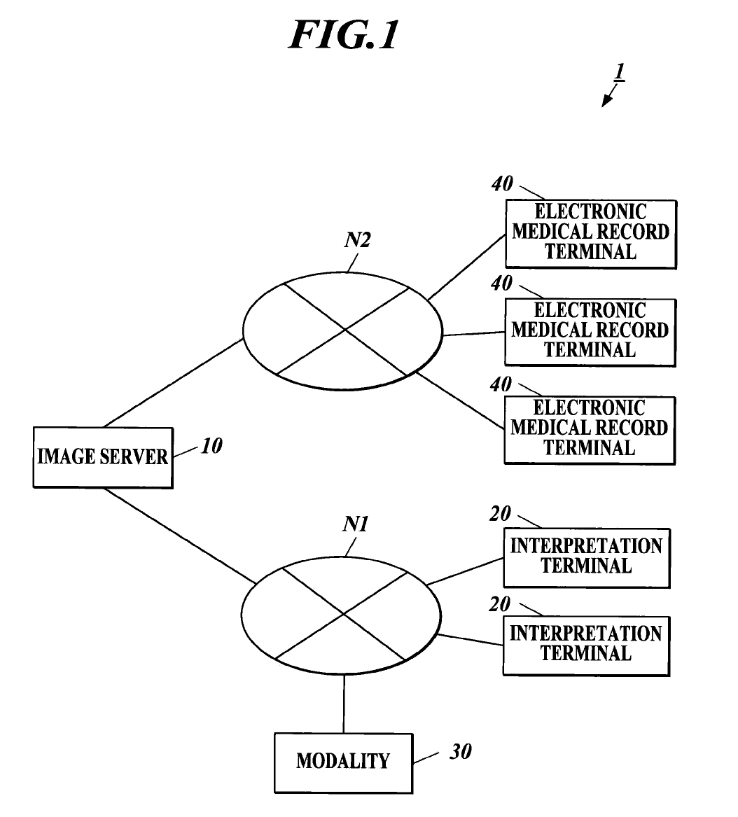

FIG. 1 shows a medical image system 1 according to embodiments of the present invention.

The medical image system 1 includes a first system and a second system. In the first system, an image server 10, interpretation terminals 20 and a modality 30 are connected to each other via a network N1. In the second system, the image server 10 and electronic medical record terminals 40 are connected to each other via a network N2. The first system is used by interpreting physicians who mainly interpret medical images. The second system is used by examining physicians who perform medical examination using interpretation results.

Reference will now be made to the first system.

The image server 10 generates a DICOM-compliant medical image from a photographic image generated by the modality 30 based on photographing, and stores and manages the medical mage. The image server 10 also stores interpretation reports generated by the interpretation terminals 20.

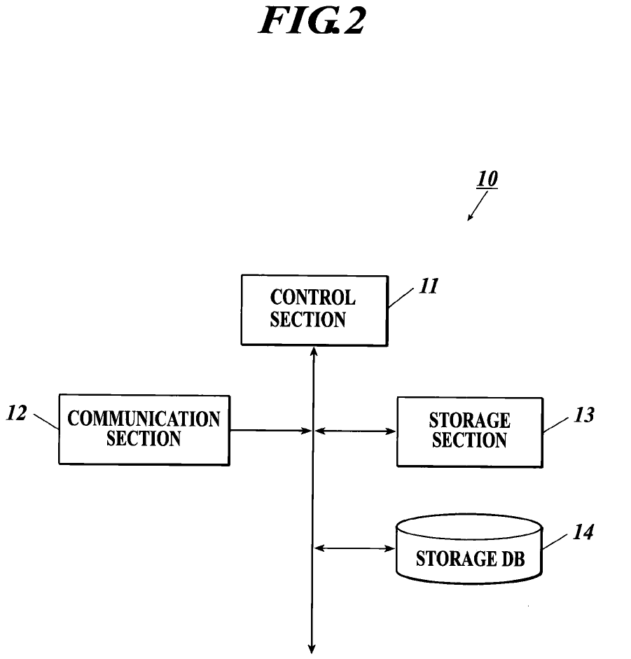

FIG. 2 shows a configuration of the image server 10.

As shown in FIG. 2, the image server 10 includes a control section 11, a communication section 12, a storage section 13, and a storage DB (Data Base) 14.

The control section 11 controls the respective sections and executes various processing in cooperation with a control program stored in the storage section 13.

The control section 11 unifies management of the medical images using order information sent from the electronic medical record terminals 40. The order information will be described later.

The communication section 12 includes a communication interface to communicate with the respective devices on the networks N1 and N2. It should be noted that a DICOM protocol is employed when delivering medical images to the interpretation terminals 20, whereas a protocol for commonly-used Web communication such as HTTP is employed when delivering medical images to the electronic medical record terminals 40.

The storage section 13 stores a control program and parameters and files needed for executing the program.

The storage DB 14 has a large-capacity memory to store medical images and interpretation reports.

The interpretation terminal 20 is configured to display a medical image to allow an interpreting physician to interpret the medical image. One example of the interpretation terminal 20 is a PC (personal computer) on which a browsing software for medical images has been installed. That is, the interpretation terminal 20 includes a control section, an operating section, a display section, a communication section, and a storage section.

The interpretation terminal 20 has a function of generating an interpretation report. During the interpretation, the interpretation terminal 20 displays a medical image acquired from the image server 10 as well as an interpretation report generation screen. Input information on the generation screen serves as an interpretation report.

The modality 30 is configured to generate a photographic image based on photographic examination. Examples of the modality 30 include a CR (Computed Radiography) device, a MRI (Magnetic Resonance Imaging) device, and a CT (Computed Tomography) device.

Next, reference will be made to the second system.

The second system provides the electronic medical record terminals 40 with medical images and interpretation reports, both of which are stored in the image server 10.

The electronic medical record terminal 40 has a function of generating an electronic medical record, and is configured to display a medical image and an interpretation report to allow an examining physician to perform medical examination. The electronic medical record terminal 40 is configured to generate order information on a medical image and send the order information to the image server 10 in order to specify a photographing condition and an interpretation condition of the medical image.

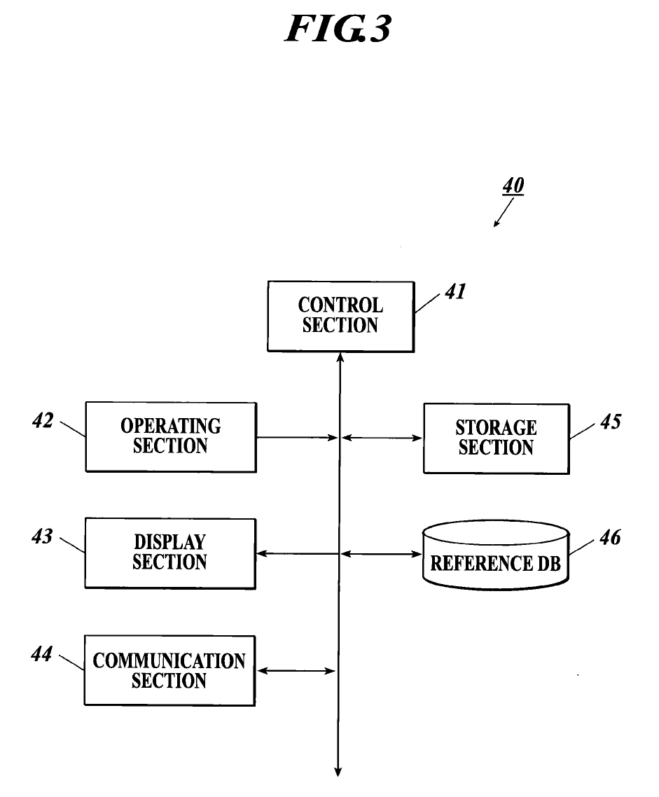

FIG. 3 shows a configuration of the electronic medical record terminal 40.

As shown in FIG. 3, the electronic medical record terminal 40 includes a control section 41, an operating section 42, a display section 43, and a communication section 44, a storage section 45, and a reference DB 46.

The control section 41 has CPU and RAM, and controls the respective sections and executes various processing in cooperation with programs, such as control programs for generating electronic medical records, which are stored in the storage section 45. For example, the control section 41 executes generating processing of an electronic medical record in cooperation with an electronic medical record program, and performs various image processing on a medical image in cooperation with an image processing program.

The operating section 42 has a mouse and a keyboard, and generates an operation signal in response to an operation of the mouse or the keyboard to output the operation signal to the control section 41.

The display section 43 has a display for displaying various operation screens, such as a medical image display screen and an electronic medical record generation screen, under the control of the control section 41.

The communication section 44 includes a communication interface to communicate with the image server 10 on the network N1.

The storage section 45 stores the above-described control programs and parameters and files needed for executing the programs.

The reference DB 46 is a memory for storing medical images and interpretation reports, both of which are acquired for reference, and the generated electronic medical records.

Next, reference will be made to an operation of the medical image system 1.

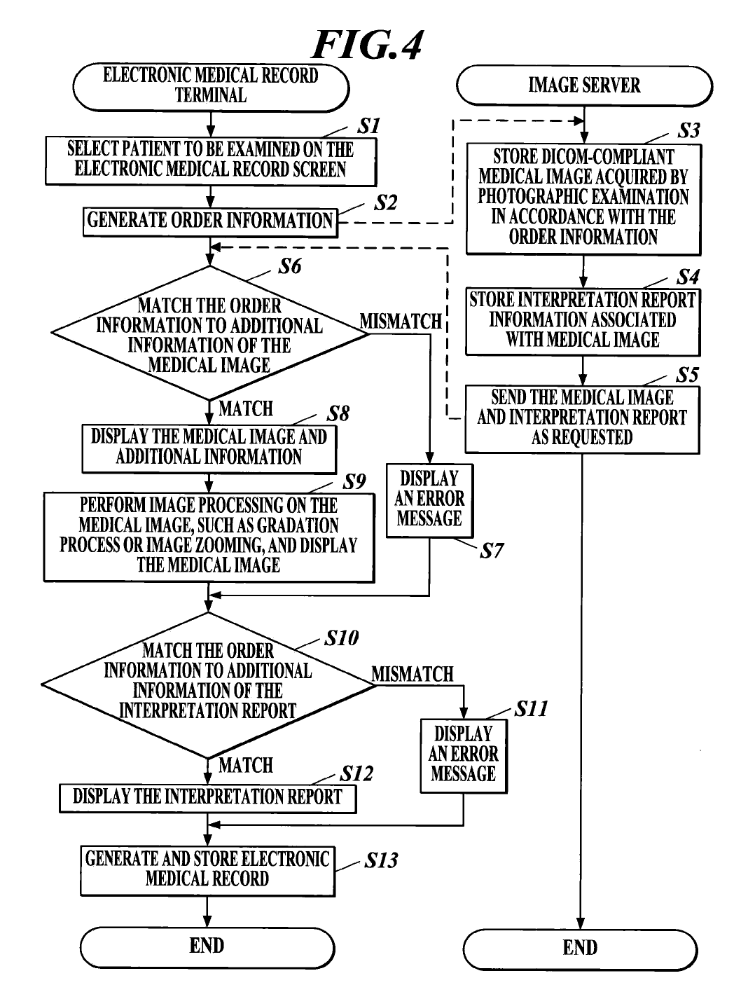

FIG. 4 shows a flowchart for explaining processing executed between the electronic medical record terminal 40 and the image server 10 in the medical image system 1.

First, in the electronic medical record terminal 40, the control section 41 runs the electronic medical record program, and causes the display section 43 to display the electronic medical record generation screen. A patient to be examined is selected on the generation screen (step S1). An input item for entering information on a patient to be examined and an option item for choosing whether photographic examination is conducted, appear on the electronic medical record generation screen. The electronic medical record generation screen allows an examining physician to select a patient and specify the photographic examination by entering information in these items.

When the photographic examination is specified, the control section 41 causes the display section 43 to display a setting screen for entering order information on a medical image to be acquired in the photographic examination, such as a specifying condition for the photographic examination and a specifying condition for interpretation. One example of the specifying condition for the photographic examination is a specifying condition for specifying photographing time and date, a body part to be photographed, a photographing direction, and whether a contrast agent is needed. One example of the specifying condition for interpretation is specification of an interpreting physician and information on a body part to be examined that requires particular attention. When the specifying conditions are entered, the control section 41 generates order information based on the entered information (step S2).

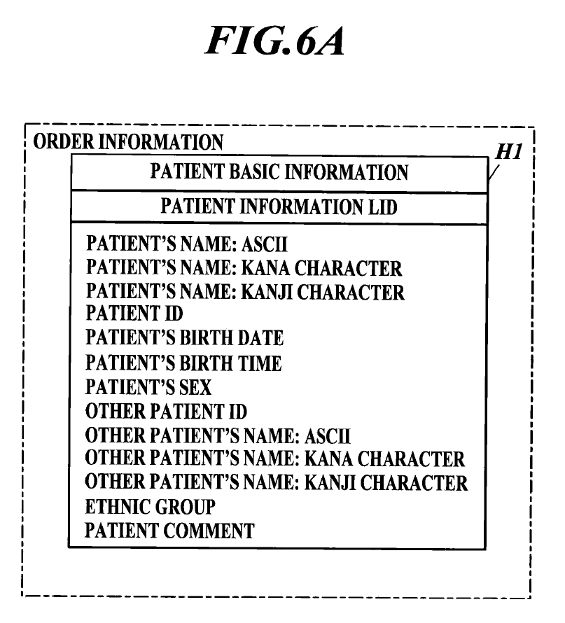

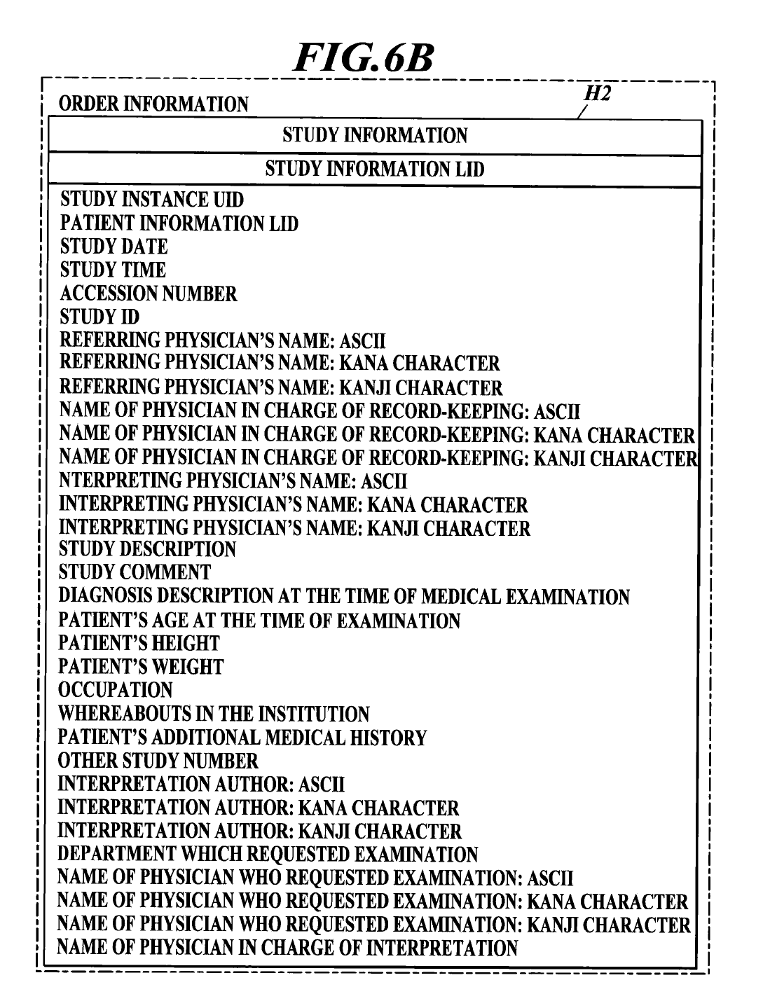

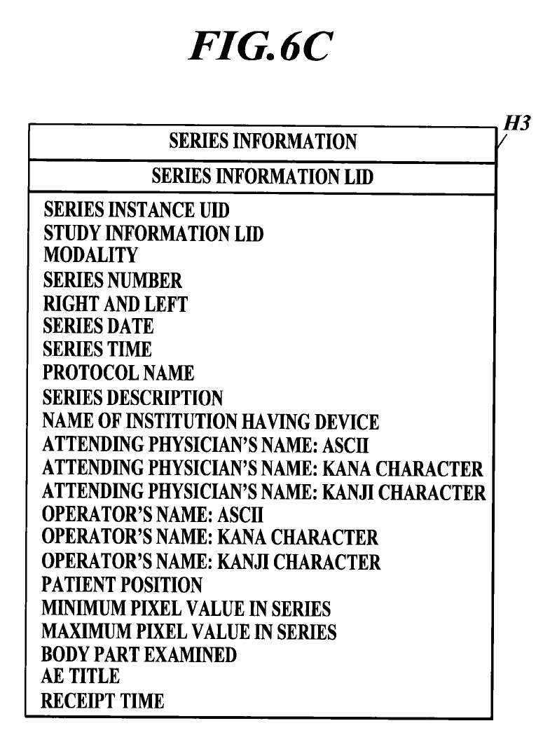

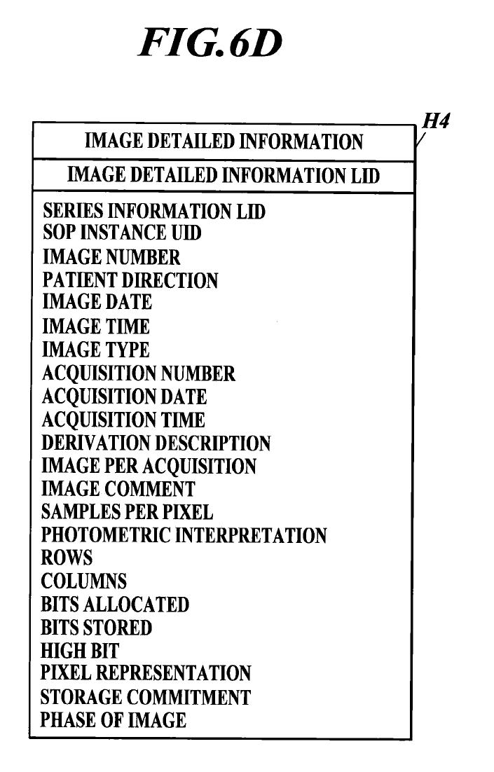

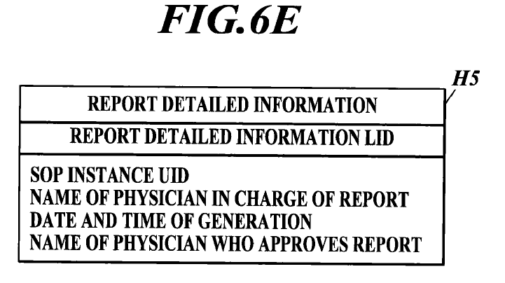

The order information is specifying information on a series of processes from photographing a patient to generating and interpreting a medical image, and on operations. The order information includes information for specifying a patient to be photographed and an interpreting physician who interprets a medical image, for example. FIGS. 6A to 6E show exemplary additional information of a medical image. As shown in FIGS. 6A and 6B, the order information includes patient basic information H1 and study information H2. The patient basic information H1 is specifying information on a patient to be photographed (such as a name of the patient to be photographed). The study information H2 is specifying information on photographic examination and interpretation (such as study date on which photographing is to be performed, and a name of a specified interpreting physician).

Series information H3, image detailed information H4 and report detailed information H5 shown in FIGS. 6C to 6E are information which is generated in the process of photographing and interpretation after the order information is placed, and are an information group which is to be added to a photographic image along with the order information (the additional information will be described later). The series information H3 is information on associated images which are obtained in a series of examination (such as a modality which is used in the examination). The image detailed information H4 is information on a generation condition of a medical image (such as an image type). The report detailed information H5 is information on an interpretation report (such as a name of a physician in charge of generating an interpretation report). As identification information, a patient information LID, a study information LID, a series information LID, an image detailed information LID and a report detailed information LID are attached to the information H1 to H5, respectively. Moreover, SOP instance UIDs are attached for identifying a series of the information H1 to H5. ID information of one of the pieces of the information H1 to H5 is included in the other so that the information H1 to H5 can associate with each other.

The order information is referred to by an operator and an interpreting physician during the subsequent photographic examination and interpretation. Photographing, generation of a medical image, and interpretation can be performed in accordance with the instructions of the order information. This allows an examining physician to obtain a desired medical image.

The generated order information is stored into the storage section 45 under the control of the control section 41, and sent to the image server 10 and a RIS (Radiology Information System) (not shown) via the network N2. The RIS delivers the order information to the modality 30. The modality 30 displays the order information. The operator refers to the displayed order information, and sets the specified photographing condition and generation condition for the modality 30 to take photographs.

The modality 30 takes photographs according to the photographing condition specified in the order information, and then generates a photographic image according to the specified generation condition. The generated photographic image is transferred to the image server 10.

The control section 11 of the image server 10 generates a DICOM-compliant medical image from the photographic image, which is acquired from the modality 30, based on the order information, and stores the medical image into the storage DB 14 (step S3). With respect to additional information on a medical image, which is added to the medical image, DICOM has a standard for contents and a file format of the additional information so that the medical image can be exchanged between different devices. The DICOM-compliant medical image is generated according to this standard.

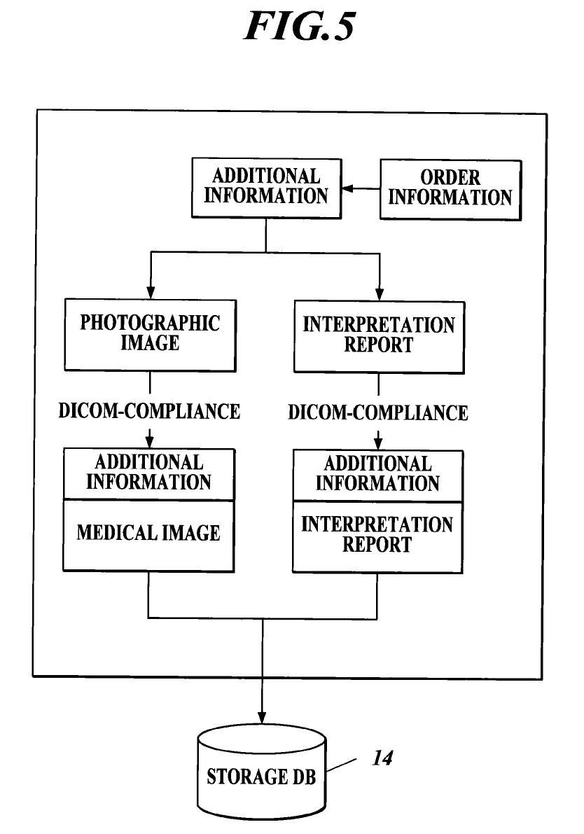

A generation process of a DICOM-compliant medical image under the control of the control section 11 will be described with reference to FIG. 5.

First, the control section 11 generates additional information based on the order information. The additional information is generated by adding the above-described series information and image detailed information to the order information. As shown in FIGS. 6A to 6E, the additional information includes patient basic information H1 (name, birth date), study information H2 (study time and date, name of a physician who requested examination, name of an operator, etc.), series information H3 (modality, patient position, body part examined, etc.) and image detailed information H4 (the number of bits allocated of a photographic image, compression rate, etc). The modality 30 generates the series information and the image detailed information when generating a photographic image. The image server 10 acquires the series information and the image detailed information along with the photographic image.

Next, the control section 11 adds this additional information to the photographic image acquired from the modality 30 to generate a DICOM-compliant medical image. The generated medical image is stored in the storage DB 14. The medical image in the storage DB 14 is specified individually and managed based on the additional information.

The medical image, which is under the control of the image server 10, is to be provided to the interpretation terminal 20. The control section 11 of the image server 10 delivers the medical image stored in the storage DB 14, to the interpretation terminal 20. The interpretation terminal 20 displays the delivered medical image for interpretation by an interpreting physician, along with the additional information of the medical image such as instruction information on the interpretation. The interpretation terminal 20 also displays the interpretation report generation screen. The interpreting physician may interpret the medical image displayed on the interpretation terminal 20, and enter the finding on the generation screen. The interpretation terminal 20 generates an interpretation report based on the input on the generation screen, and sends the interpretation report to the image server 10. Identification information for identifying which examination image the interpretation report has been generated for, such as patient UID and study UID, is also sent in a manner associated with the interpretation report.

The image server 10 determines which medical image the interpretation report received from the interpretation terminal 20 corresponds to, based on the identification information, and then stores the interpretation report and the medical image into the storage DB 14 in a manner associated with each other (step S4). The interpretation report is associated with the medical image using the additional information on the medical image. That is, the same additional information as that of the medical image is added to the interpretation report as shown in FIG. 5. At this time, the report detailed information H5 is added to the additional information so that the interpretation report is DICOM-compliant. The report detailed information H5 is generated by the interpretation terminal 20 when generating the interpretation report. The image server 10 acquires the report detailed information H5 along with the interpretation report.

The processing in the first system terminates at this step. As described above, the first system is involved in from the generation of a medical image to the interpretation.

The medical image and the interpretation report stored in the image server 10 is delivered to the electronic medical record terminal 40 for examination by the examining physician, which is performed in the second system.

First, in response to a request from the electronic medical record terminal 40, the control section 11 of the image server 10 reads out the requested medical image and interpretation report from the storage DB 14, and causes the medical image and the interpretation report to be delivered to the electronic medical record terminal 40 (step S5). The same additional information is attached to the medical image and the interpretation report. During the delivery, a protocol for commonly-used Web communication, such as HTTP (HyperText Transfer Protocol) or FTP (File Transfer Protocol), is used between the communication section 44 of the electronic medical record terminal 40 and the communication section 12 of the image server 10, instead of DICOM.

The control section 41 of the electronic medical record terminal 40 reads out the order information from the storage section 45, and matches the order information to the additional information of the medical image which is sent from the image server 10 to determine whether the medical image corresponds to the order information (step S6). The matching may be conducted by extracting items needed for identifying the medical image, such as patient ID, patient's name, and study ID. Extraction of all the items is not needed for the matching. If the medical image has been generated in accordance with the order information, the order information is matched to the additional information because the additional information is generated based on the order information. On the other hand, if a medical image of another patient, which is different from a requested patient image, is sent by mistake, mismatching occurs with respect to a lot of items such as patient ID.

If the order information does not match to the additional information (step S6; mismatch), the control section 41 determines that the delivered medical image is not a requested patient image, and causes the display section 43 to display an error message notifying the determination result (step S7).

On the other hand, if the order information matches to the additional information (step S6; match), the control section 41 determines that the delivered medical image is a requested patient image, and causes the display section 43 to display the medical image and the additional information as a determination result that the medical image corresponds to the order information (step S8).

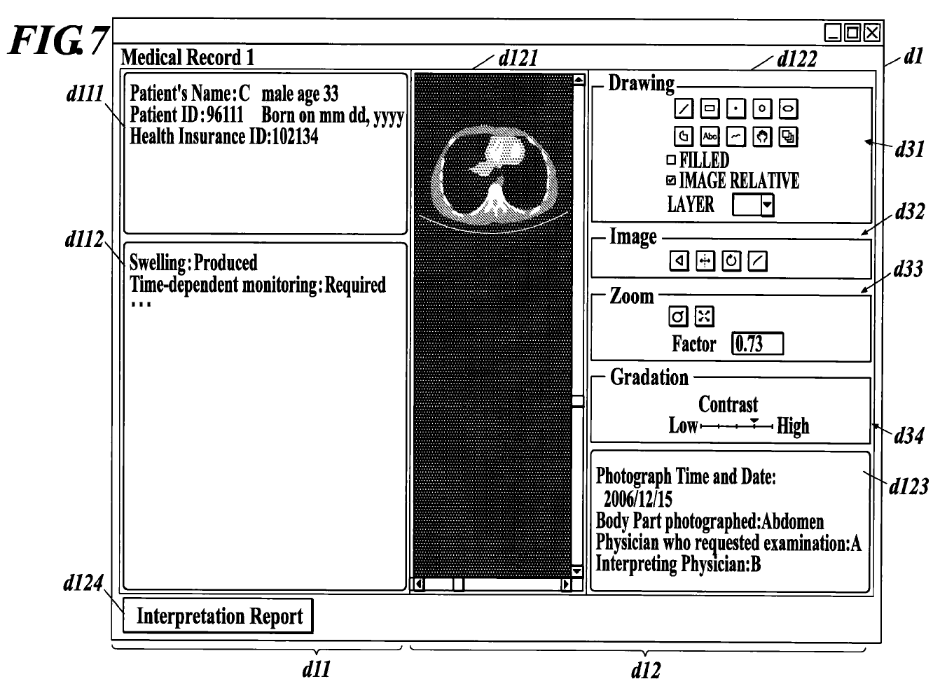

FIG. 7 shows a display example.

As shown in FIG. 7, the medical image and the additional information thereof appear on a medical record generation screen d1.

The medical record generation screen d1 includes a medical record entry area d11 and a medical image display area d12. The medical record entry area includes a medical record A area dill and a medical record B area d112. The medical record A area dill is an entry area for patient's record, such as patient's name, sex, and patient ID. The medical record B area is an entry area for medical examination, such as finding, observation, diagnosis, and treatment planning.

The medical image display area d12 includes a medical image area d121, an image processing tool area d122, and an additional information display area d123. The medical image area d121 is an area for displaying a medical image sent from the image server 10. The image processing tool area d122 includes a drawing tool d31 for embedding line drawing or characters in the medical image, an image tool d32 for image operation, a zoom tool d33, and a gradation tool d34 for gradation conversion.

Since the medical image which has been sent from the image server 10 is not JPEG data or PDF data, the electronic medical record terminal 40 can perform the image processing, such as gradation processing or zooming, on the medical image. Each of the tools d31 to d34 serves as an operational tool for the image processing.

The drawing tool d31 has keys for specifying an object to be embedded such as line drawing or characters. The image tool d32 has instruction keys for manipulations of rotation, position moving, trimming, and thumbnail-pasting. The zoom tool d33 has selection keys for zooming in and out, and an entry field of zoom factor. The gradation tool d34 makes it possible to select a desired gradation using a contrast tuning bar. These tools d31 to d34 allow an examining physician to specify the types of image processing and to specify the image processing conditions when performing the image processing on the medical image displayed on the image area d121.

Some of the additional information of the medical image (see FIGS. 6A to 6E) appear on the additional information display area d123. The display area d123 may have a detail key so that the other additional information appears by manipulating the detail key.

The medical image display area d12 has an interpretation report key d124 for an instruction to display an interpretation report of the medical image on the image area d121. The manipulation of the interpretation report key d124 allows the examining physician to see the interpretation report of the medical image.

When being instructed to perform the image processing by manipulating the tools d31 to d34 on the medical record generation screen d1, the control section 41 performs the specified image processing on the medical image in accordance with the specified image processing conditions. The control section 41 causes the display section 43 to display the image-processed medical image (step S9).

Next, when the interpretation report key d124 is manipulated, the control section 41 reads out the additional information of the interpretation report which has been sent from the image server 10 in a manner associated with the medical image, and matches the order information stored in the storage section 45 to the additional information to determine whether the interpretation report corresponds to the order information (step S10). The additional information of the medical image has to correspond to the order information. Because the same additional information is attached to the medical image and the interpretation report thereof, if the interpretation report is a correct interpretation report of the displayed medical image, the order information has to correspond to the additional information of the interpretation report. If an interpretation report of another medical image is acquired, the additional information does not correspond to the order information.

In order to check whether the interpretation report corresponds to a patient specified in the order information, items such as patient ID and patient's name may be checked. In order to check the contents of the interpretation, such as whether the interpretation has been made in accordance with the order information, an interpreting physician's name in the study information H2 of the order information may be checked against a name of physician in charge of report in the report detailed information H5 of the additional information, for example.

If the order information does not match to the additional information (step S10; mismatch), the control section 41 generates an error message notifying that the interpretation report does not correspond to the order information, as a determination result, and causes the display section 43 to display the error message (step S11), where the algorithm terminates.

On the other hand, if the order information matches to the additional information (step S10; match), the control section 41 determines that the delivered interpretation report is a correct interpretation report corresponding to the displayed medical image, and causes the display section 43 to display the interpretation report as a determination result (step S12).

After that, when an medical record is entered on the entry area d11, the control section 41 generates an electronic medical record on the basis of the input information and the thumbnail of the medical image on the electronic medical record screen (step S13). The generated electronic medical record is stored in the reference DB 46, where the algorithm terminates.

As described above, according to the embodiments of the present invention, the electronic medical record terminal 40 generates and stores order information on a medical image, such as generation and interpretation of the medical image. The image server 10 generates additional information of the medical image based on the order information, and sends the medical image and the additional information to the electronic medical record terminal 40. Accordingly, the electronic medical record terminal 40 can determine whether the medical image is for the patient concerned, i.e., determine authenticity of the medical image by matching the additional information of the medical image to the order information. The electronic medical record terminal 40 can also determine whether the medical image is consistent with the instruction in the order information.

The conventional electronic medical record terminal receives a medical image which has been converted to a data format with a small amount of data that can be easily displayed, such as JPEG. Since only the JPEG image is delivered, an examining physician who uses the electronic medical record terminal cannot check a photographing condition of the image nor check whether the JPEG image is for the patient concerned.

On the other hand, according to the above-described embodiments, because a medical image is sent to the electronic medical record terminal 40 without compression, additional information of the medical image can be delivered. Since the additional information is generated based on the order information in accordance with the DICOM standard, it is possible to determine the authenticity of the medical image by matching the additional information to the order information stored in the electronic medical record terminal 40.

The electronic medical record terminal 40 displays the medical image acquired from the image server 10, along with the additional information of the medical image, which allows the examining physician to see the medical image and the additional information on the medical record generation screen d1. Accordingly, based on the additional information, the examining physician can easily check a photographing condition of the medical image and check whether the photographing is carried out as instructed.

The medical image can be processed on the medical record generation screen d1 for different purposes, such as for changing the medical image into a desired image that the examining physician wants to view, and for generating an image which facilitates use of the electronic medical record. In particular, the image processing can be carried out in an integrated manner with the electronic medical record function without separately displaying the medical image and separately running software for image processing. This allows the examining physician to perform a physical examination efficiently.

The order information generated by the electronic medical record terminal 40 contains an instruction for interpretation. The image server 10 attaches the additional information of the medical image to the interpretation report generated by the interpretation terminal 20. The electronic medical record terminal 40 matches the additional information of the interpretation report sent from the image server 10, to the order information stored in the electronic medical record terminal 40. This matching process makes it possible to determine whether the interpretation report is consistent with the requested medical image and to determine whether the interpretation has been made as instructed and whether the interpretation report has been generated as instructed.

Display of the additional information allows the examining physician to readily confirm whether the interpretation has been made as instructed and whether the interpretation report has been generated as instructed. For example, if the additional information contains interpretation time and date or a name of a physician who has approved the interpretation report, it is possible to confirm whether the interpretation has been made before the designated time and date or whether the interpretation report has been approved by the designated physician, by seeing the additional information.

A protocol for Web communication is used when delivering the medical image to the electronic medical record terminal 40 from the image server 10, instead of using a protocol for DICOM which is commonly-used for medical image communication. Such a communication eliminates the need for establishing a DICOM-compliant system between the image server 10 and the electronic medical record terminal 40, and a simple system configuration can be achieved at low cost.

### INDUSTRIAL APPLICABILITY

The present invention can be utilized in the medical imaging field.

### DESCRIPTION OF REFERENCE NUMERALS

1 medical image system
10 image server
11 control section
14 storage DB
20 interpretation terminal
30 modality
40 electronic medical record terminal
41 control section
42 operating section
43 display section
46 reference DB

1. A medical image system, comprising:
an image server to store a medical image in a manner associated with additional information on the medical image; and
an electronic medical record terminal to generate an electronic medical record, wherein
the electronic medical record terminal comprises:
a storage section to store order information on the medical image stored in the image server;
an acquiring section to acquire the medical image and the additional information from the image server; and
a determination control section to determine whether the acquired medical image is based on the order information using the acquired additional information of the medical image and the stored order information of the medical image, and to output a determination result.

2. The medical image system of claim 1, wherein
the electronic medical record terminal further comprises:
a display section to display a medical image; and
a display control section to cause the display section to display the acquired medical image if the determination control section determines that the acquired medical image is based on the order information.

3. The medical image system of claim 2, wherein
the display control section causes the acquired medical image and the additional information thereof to be displayed.

4. The medical image system of claim 2, wherein
the electronic medical record terminal further comprises an image processing section to perform image processing on the acquired medical image, and
the display control section causes the display section to display the medical image on which the image processing has been performed.

5. The medical image system of claim 1, wherein
the acquiring section acquires the medical image in accordance with a protocol for Web communication.

6. The medical image system of claim 1, wherein
the image server stores an interpretation report of the medical image in a manner associated with additional information of the medical image,
the acquiring section of the electronic medical record terminal acquires the medical image and the interpretation report thereof from the image server, and
the determination control section of the electronic medical record terminal determines whether the acquired interpretation report is based on the order information using the additional information of the acquired interpretation report and the order information, and to output a determination result.

7. The medical image system of claim 6, wherein
the electronic medical record terminal further comprises:
a display section to display an interpretation report; and
a display control section to cause the display section to display the medical image if the determination control section determines that the acquired interpretation report is based on the order information.

8. An electronic medical record terminal for generating an electronic medical record, comprising:
a storage section to store order information on a medical image which is stored in an image server in a manner associated with additional information on the medical image;
an acquiring section to acquire the medical image and the additional information from the image server; and
a determination control section to determine whether the acquired medical image is based on the order information using the acquired additional information of the medical image and the stored order information of the medical image, and to output a determination result.

9. A computer-readable medium embodying a program causing a computer to function as:
a storage control section to cause a storage section to store order information on a medical image which is stored in an image server in a manner associated with additional information on the medical image;
an acquiring section to acquire the medical image and the additional information from the image server; and
a determination control section to determine whether the acquired medical image is based on the order information using the acquired additional information of the medical image and the order information of the medical image, which is stored in the storage section, and to output a determination result.
